(19) United States
(12) Patent Application Publication
(10) Pub. No.: US 2010/0042730 A1
(43) Pub. Date: Feb. 18, 2010

(54) DEVICE AND METHOD FOR DATA TRANSMISSION USING DUAL PROTOCOL STACKS

(75) Inventor: Chi-Cheng KANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/241,092

(22) Filed: Sep. 30, 2008

(30) Foreign Application Priority Data
Aug. 15, 2008 (CN) 200810303849.0

(51) Int. Cl. G06F 15/16

(52) U.S. Cl. 709/228

(57) ABSTRACT

An intermediate device for data transmission includes an interface and a wireless module, the interface establishing a local connection with an electronic device and the wireless module establishing a remote connection with a server for the electronic device. Different network parameter values are adopted for the local connection and the remote connection. A method for data transmission is also provided.

### BACKGROUND

1. Field of the Invention

Embodiments of the present disclosure relate to devices and methods for data transmission, and more particularly to a device and method for data transmission using dual protocol stacks.

2. Description of Related Art

With an increased demand for wireless services, new communications technologies are being developed, such as High Speed Downlink Packet Access (HSDPA), an advanced version of Third-generation Wideband Code Division Multiple Access (3G WCDMA), which provides a higher data rate, i.e., 14 Mbps, than WCDMA. Such data rates can support applications such as mobile TV, online gaming, streaming media, and others.

Desktop computers connecting to the Internet by network adaptor and physical network ports provided by Internet Service Provider (ISP) can also access the Internet by wireless media when the network adaptor or physical network ports are absent or fail. As shown in FIG. 4, a desktop computer 400 can first connect to a portable electronic device 300 through an interface, such as Bluetooth or USB, and then to a remote server 100 by the portable electronic device 300 to establish a TCP/IP connection. The TCP/IP connection includes a local wired/wireless connection and a remote wireless connection.

Generally, parameters adopted by the local connection are suitable for local use. For example, one important parameter, “sliding window” defines the number of packets that can be transmitted by a transmitter or received by a receiver within a time period. Upon receiving an acknowledge (ACK) regarding one transmitted packet, the sliding window of the transmitter can move backward for one window, at which time a packet can be transmitted to fill the sliding window. Thus, for the local connection, a smaller sliding window is generally adopted since the transmitter will receive the corresponding ACK confirmation quickly. In addition, the packet transmitted by the local connection is often defined to have a shorter Round-Trip Time (RTT).

For a typical situation as shown in FIG. 4, connection between the desktop computer 400 and the remote server 100 relates to a remote connection, whereby remote-connection parameters are adopted. However, it takes a long time to receive the ACK confirmation of transmitted packets because of the limitations of the wireless remote connection. Thus, a fixed number of transmitted packets fills the sliding window of the desktop computer 400 and await corresponding ACK confirmation. Throughput of the desktop computer 400 decreases due to the adoption of unsuitable parameters.

Accordingly, a device and a method for data transmission using dual protocol stacks are desirable in order to overcome the limitations described.

### SUMMARY

An intermediate device for data transmission using dual protocol stacks includes an interface and a wireless module. The interface establishes a local connection with an electronic device. The wireless module establishes a remote connection with a server for the electronic device. The intermediate device adopts different network parameter values for local and remote connections.

Other advantages and novel features of the present device and method for data transmission using dual protocol stacks will become more apparent from the following detailed description of preferred embodiments when taken in conjunction with the accompanying drawings.

### BRIEF DESCRIPTION OF THE DRAWINGS

FIG. 1 is a system view of an embodiment of an intermediate device operating in an infrastructure including a user terminal, a base station, and a remote server;

FIGS. 2a and 2b are views of protocol stacks of a user terminal, an intermediate device, and a remote server of FIG. 1;

FIG. 3 is a flowchart of an embodiment of a method for data transmission employing an intermediate device with dual protocol stacks; and

FIG. 4 is a system view of a typical infrastructure for sharing network services by an intermediate device.

### DETAILED DESCRIPTION

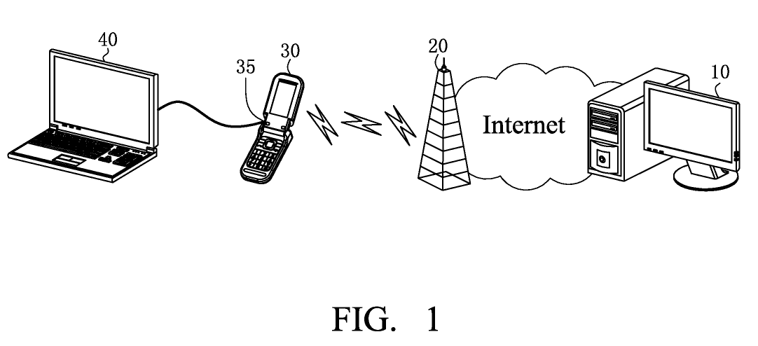

FIG. 1 is a system view of an embodiment of a system installed on an intermediate device 30, such as a mobile phone, operating in an infrastructure for data transmission. In an embodiment, the infrastructure also includes a user terminal 40, a base station 20, and a remote server 10. The intermediate device 30 shares network connections to the Internet provided by the base station 20 with the user terminal 40 so that the user terminal 40 can connect to the remote server 10. In other embodiments, other portable and non-portable electronic devices, such as notebook computers, and personal digital assistants (PDAs), are equally applicable in the system of the present disclosure without limiting the scope of the disclosure.

The intermediate device 30 includes a local interface 35 and a wireless module (not shown). As shown in FIG. 1, the intermediate device 30 provides network sharing services for a user terminal 40, here a desktop computer, to allow the user terminal 40 to connect to the remote server 10 via the Internet. The user terminal 40 first establishes a local connection with the intermediate device 30 by local interface 35. The local interface 35 may be USB or Bluetooth but the disclosure is not limited thereto.

After the local connection is established, the intermediate device 30 connects to the remote server 10 by the wireless module, such as a GPRS module, a EDGE (Enhanced Datarate for GSM Evolution) module, a WCDMA module, or a HSPA module, although the disclosure is not limited thereto. The GPRS module is used here as an example.

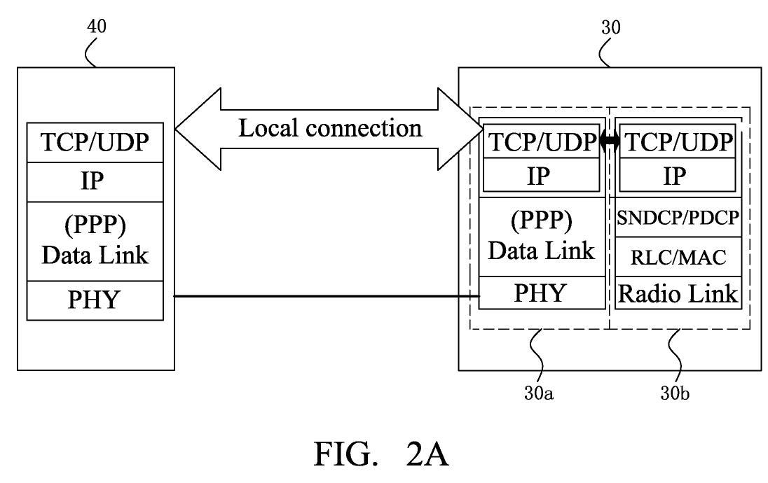

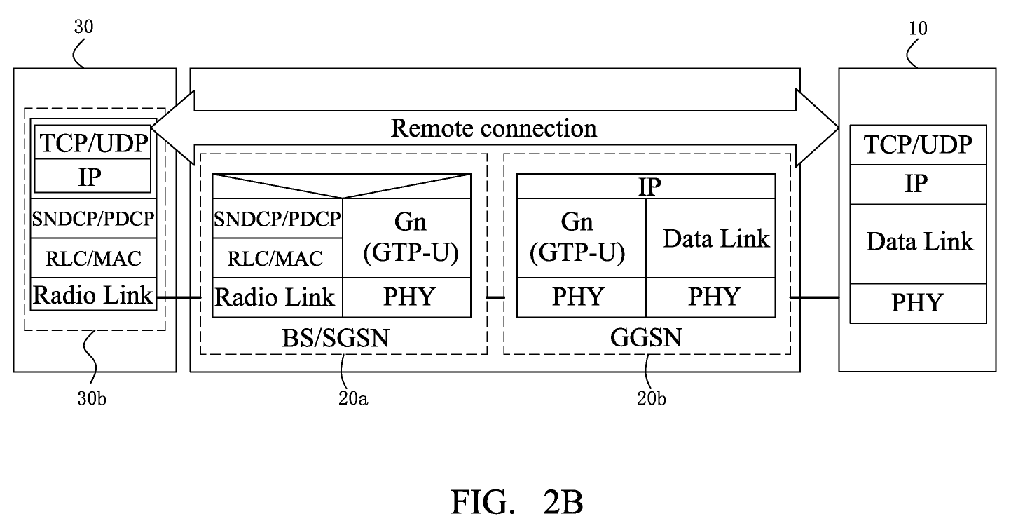

FIG. 2a is a view of protocol stacks of the user terminal 40 and the intermediate device 30 of FIG. 1. The protocol stack of the intermediate device 30 includes a local protocol stack 30a and a remote protocol stack 30b. The local protocol stack 30a of the intermediate device 30 corresponds to the protocol stack of the user terminal 40.

As the local connection between the intermediate device 30 and the user terminal 40 is established by the local interface 35, the traffic rate therebetween is considerably high. Therefore, suitable parameters values for the local connection, such as shorter RTT and smaller sliding window, are adopted to increase throughput between the intermediate device 30 and the user terminal 40.

FIG. 2b is a view of protocol stacks of the remote protocol stack 30b of the intermediate device 30, the base station 20, and the remote server 10. The remote connection between the intermediate device 30 and the remote server 10 includes one BS/SGSN (Base Station/Serving GPRS Support Node) protocol stack 20a and one (Gateway GPRS Support Node) protocol stack 20b. The BS/SGSN protocol stack 20a routs packets within service areas and between the BS/SGSN and the GGSN. The GGSN protocol stack 20b transmits/receives packets between the GPRS network and other data networks.

One end of the BS/SGSN protocol stack 20a corresponds to layers 1 through 3 of the remote protocol stack 30b of the intermediate device 30 to provide telecommunication services, and the other end of the BS/SGSN protocol stack 20a corresponds to one end of the GGSN protocol stack 20b to provide the routing between the BS/SGSN and the GGSN. The other end of the GGSN protocol stack 20b also corresponds to the lower layers, 1 through 3, of the protocol stack of the remote server 10 to provide routing between the GGSN and the remote server 10.

As shown in FIG. 2b, layer 4 of the remote protocol stack 30b of the intermediate device 30, the TCP/UDP layer, directly corresponds to the TCP/UDP layer of the remote server 10. Compared to the local connection, the remote protocol stack 30b adopts parameters values suitable for long-distance connection, such as a longer RTT and a larger sliding window.

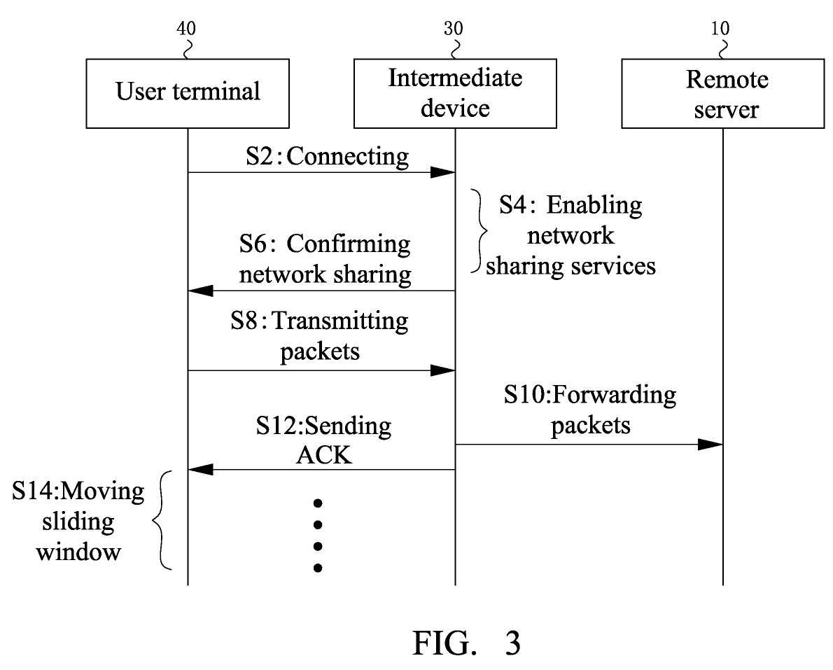

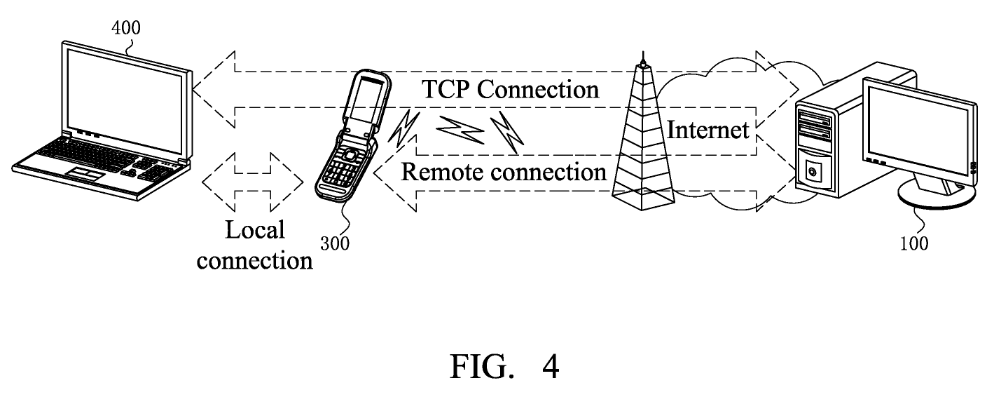

FIG. 3 is a flowchart of an embodiment of a method for data transmission by an intermediate device with dual protocol stacks. The method of FIG. 3 may be used to establish a local connection between the user terminal 40 and the intermediate device 30 and a remote connection between the intermediate device 30 and the remote server 10. Additional blocks may be added or deleted and the blocks may be executed in an order other than that described without affecting the scope of the disclosure.

In block S2, the user terminal 40 connects to the intermediate device 30 by a local interface 35. Upon detecting that the connection between the user terminal 40 and the intermediate device 30 is established, in block S4, the intermediate device 30 enables network sharing services. In block S6, the intermediate device 30 sends a message to notify the user terminal 40 that network sharing services are enabled.

In block S8, the user terminal 40 transmits packets to the remote server 10. It is to be noted that while the destination of the packet is the remote server 10, the intermediate device 30 acts as a virtual destination for the packet sent from the user terminal 40. In addition, upon receiving the packets, in block S10, the intermediate device 30 forwards the received packets to the remote server 10, and the intermediate device 30 acts as virtual source.

In block S12, the intermediate device 30 sends an ACK confirmation corresponding to the forwarded packet to the user terminal 40. Upon receiving the ACK confirmation, in block S14, the user terminal 40 moves the sliding window back and sends a new packet to fill the sliding window.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An intermediate device for data transmission, comprising:
an interface for establishing a local connection with an electronic device;
a wireless module for establishing a remote connection with a server for the electronic device; and
wherein the intermediate device adopts network parameter values for the local connection and different network parameter values for the remote connection.

2. The device as claimed in claim 1, wherein the local connection and the remote connection are established using a TCP/IP protocol stack.

3. The device as claimed in claim 2, wherein the network parameters adopted by the local connection and the remote connection include a round-trip time and a sliding window.

4. The device as claimed in claim 3, wherein the round-trip time of the local connection is shorter than the round-trip time of the remote connection.

5. The device as claimed in claim 3, wherein the sliding window of the local connection is smaller than the sliding window of the remote connection.

6. The device as claimed in claim 1, wherein the interface is a Bluetooth interface.

7. The device as claimed in claim 1, wherein the interface is a standard USB interface.

8. A method for data transmission by an intermediate device, the method comprising:
connecting to a user terminal for establishing a local connection through an interface;
connecting to a server by a wireless module to establish a remote connection;
forwarding packets initiated by the user terminal to the server; and
wherein the intermediate device adopts network parameter values for the local connection and different network parameter values for the remote connection.

9. The method as claimed in claim 8, wherein the local connection and the remote connection are established using a TCP/IP protocol stack.

10. The method as claimed in claim 9, wherein the parameters adopted by the local connection and the remote connection include a round-trip time and a sliding window.

11. The method as claimed in claim 10, wherein the forwarding step further comprises:
sending an ACK confirmation corresponding to the forwarded packet to the server.

12. The method as claimed in claim 10, wherein the round-trip time of the local connection is shorter than the round-trip time of the remote connection.

13. The method as claimed in claim 10, wherein the sliding window of the local connection is smaller than the sliding window of the remote connection.

14. The method as claimed in claim 10, wherein the interface is a Bluetooth interface.

15. The method as claimed in claim 10, wherein the interface is a standard USB interface.
